(19) United States
(12) Patent Application Publication
(10) Pub. No.: US 2006/0107698 A1
(43) Pub. Date: May 25, 2006

(54) Automatic pressure control device for quartz tube

(75) Inventors: Hak-Seon Kim, Gumi-si (KR); Yeong-Seop Lee, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/206,365

(22) Filed: Aug. 18, 2005

(30) Foreign Application Priority Data
Nov. 24, 2004 (KR) 2004-97127

(51) Int. Cl. C03B 37/07

(52) U.S. Cl. 65/489

(57) ABSTRACT

An automatic pressure control device for detecting and automatically controlling a gas pressure within a quartz tube in an optical fiber preform fabricating apparatus by regulating the flow rate of gas fed into the quartz tube in accordance with a preset pressure value is disclosed. The automatic pressure control device includes: a main flow controller coupled to a soot box to feed the gas into the quartz tube in accordance with the preset pressure value; a sub flow controller coupled to the soot box to feed the gas into the quartz tube to maintain the preset pressure value when there is a pressure change within the soot box; and a gas pressure controller having a pressure sensor inserted into the soot box to compare a pressure value of a signal detected in real time by the pressure sensor with the preset pressure value and to control the flow rate of the gas to maintain a constant level of gas pressure within the soot box.

### CLAIM OF PRIORITY

This application claims priority to an application entitled “Automatic Pressure Control Device for Quartz Tube,” filed with the Korean Intellectual Property Office on Nov. 24, 2004 and assigned Serial No. 2004-97127, the contents of which are hereby incorporated by reference.

### BACKGROUND OF THE INVENTION

1. Field of the Invention

The present invention relates to an automatic pressure control device for controlling gas pressure within a quartz tube automatically.

2. Description of the Related Art

In general, fabrication of optical fibers involves a production of an optical fiber preform. There are several methods used to prepare the optical fiber preforms, namely an outside vapor deposition (OVD), a vapor-phase axial deposition (VAD), and a modified chemical vapor deposition (MCVD).

In the OVD, a rotating target rod (an alumina mandrel) is heated with a burner's hot flame. The burner feeds chemicals to be deposited on the outside of the target rod by thermophoresis. The chemicals for a core layer is deposited initially, then followed by a different chemicals to form a cladding layer. Thus, the OVD method involves a the layer-by-layer deposition of chemicals to form a core layer on the outside of the target rod and a cladding layer on the core layer.

Meanwhile, the MCVD differs from the OVD in that the deposition occurs inside a quartz tube instead of outside. While the quartz tube is being heated by a burner, chemicals are fed into the tube to form a cladding layer on the internal wall of the tube and then a core layer on the internal wall of the cladding layer by thermophoresis.

Lastly, in the VAD, two different burners (an upper burner and a lower burner) are used to simultaneously deposit a core layer and a cladding layer on a target rod in an upright position.

FIG. 1 shows a deposition apparatus for performing an MCVD process. A horizontal lathe is provided in a chamber 1 with a hood 2, a headstock 3 and a tailstock 4 so support a quartz tube 7 in such a manner that the quartz tube 7 can rotate about its longitudinal axis. Also, a burner 6 movable along a rail 5 is provided below the quartz tube 7.

In operation, while moving along the rail 5, the burner 6 traverses back and forth along the length of the rotating quartz tube 7 and thereby heats the tube 7. Nitrogen and other chemical reactants entrained in oxygen gas are fed in the form of a gaseous mixture into the quartz tube 7 to form soot particles that will be deposited on the outer and inner walls of the quartz tube 7. The headstock 3 and the tailstock 4 rotatably hold both ends of the quartz tube 7 by means of chucks 3a and 4a.

Referring to FIG. 2, the chuck 4a is fixed to the tailstock 4. Also, a soot box is connected to the tailstock 4 to feed or discharge nitrogen gas 10 and other chemical reactants entrained in oxygen as a gaseous mixture into or from the quartz tube 7. The soot box 8 includes a nitrogen tube 8a for introducing nitrogen gas 10 and a discharge tube 8b for discharging the gas 10. An auxiliary support tube 9 is provided to support the introduction of the gas 10 into the quartz tube 7 through the nitrogen tube 8a. A hand valve 9a connected to the soot box 8 is used to control the discharge of undeposited soot and gas 10 that have been introduced into the discharge tube 8b. A gas flow controller 20 controls the flow rate of nitrogen gas 10 fed into the nitrogen tube 8a in accordance with a preset gas pressure value. Also, a pressure sensor 30 inserted into the nitrogen tube 8a detects the gas pressure inside the quartz tube 7.

However, the discharge tube may become clogged with soot when the gas pressure inside the quartz tube is changed due to an external factor during the MCVD process. If the process is continued under such an unstable condition, there will be a great change in the amount of nitrogen gas fed into the nitrogen tube, as well as in the pressure and gas stream within the quartz tube, thereby deteriorating the preform deposition quality. Moreover, since the pressure inside the quartz tube is manually controlled, it is necessary to check every change of pressure in real time and regulate the flow rate of the gas in accordance with every detected pressure.

### SUMMARY OF THE INVENTION

Accordingly, the present invention has been made to solve the above-mentioned problems occurring in the prior art and provides additional advantages, by providing an automatic pressure control device capable of detecting and automatically controlling gas pressure within a quartz tube, thus improving the quality of the resulting preform.

One aspect of the present invention is to provide an automatic pressure control device capable of detecting and automatically controlling gas pressure within a quartz tube and for stabilizing the feed of gas into the quartz tube.

Another aspect of the present invention is to provide an automatic pressure control device for controlling gas pressure within a quartz tube in an optical fiber preform fabricating apparatus having a chuck holding one end of the quartz tube and a soot box for fixing the chuck, and feeding and discharging gas into and from the quartz tube by regulating the flow rate of the gas in accordance with a preset pressure value. The automatic pressure control device includes: a main flow controller coupled to the soot box to feed the gas into the quartz tube according to a preset pressure value; a sub flow controller coupled to the soot box to feed the gas into the quartz tube to maintain the preset pressure value when there is a pressure change within the soot box; and a gas pressure controller having a pressure sensor inserted into the soot box to compare the pressure value of a signal detected in real time by the pressure sensor with the preset pressure value and to control the two flow controllers to control the flow rate of the gas to maintain a constant level of gas pressure within the soot box.

### BRIEF DESCRIPTION OF THE DRAWINGS

The above features and advantages of the present invention will be more apparent from the following detailed description taken in conjunction with the accompanying drawings, in which:

FIG. 1 shows a conventional optical fiber preform fabricating apparatus using a chemical vapor deposition process;

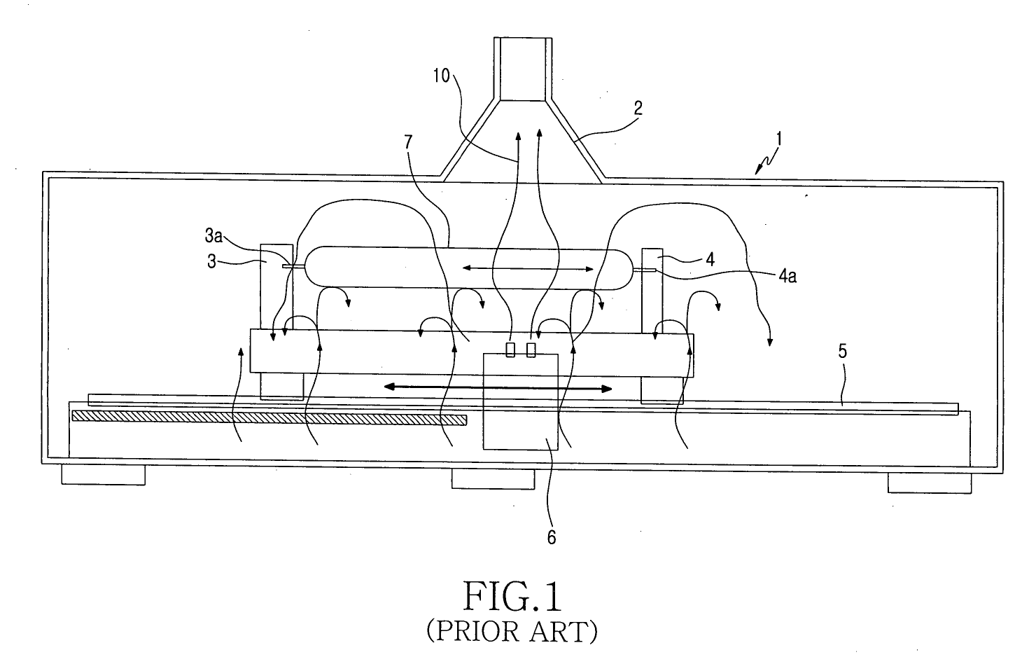

FIG. 2 shows a conventional pressure control device used to control the pressure inside a quartz tube;

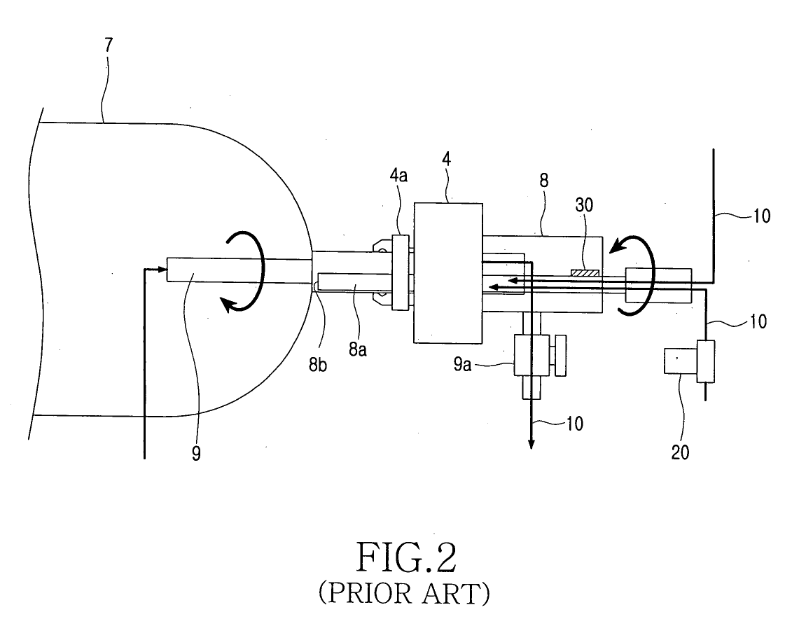

FIG. 3 is a schematic diagram showing an automatic pressure control device for a quartz tube according to the present invention; and

FIG. 4 is a schematic diagram showing a sub gas outlet of an automatic pressure control device for a quartz tube according to the present invention.

### DETAILED DESCRIPTION

Hereinafter, an embodiment of the present invention will be described with reference to the accompanying drawings. For the purposes of clarity and simplicity, a detailed description of known functions and configurations incorporated herein will be omitted as it may make the subject matter of the present invention unclear.

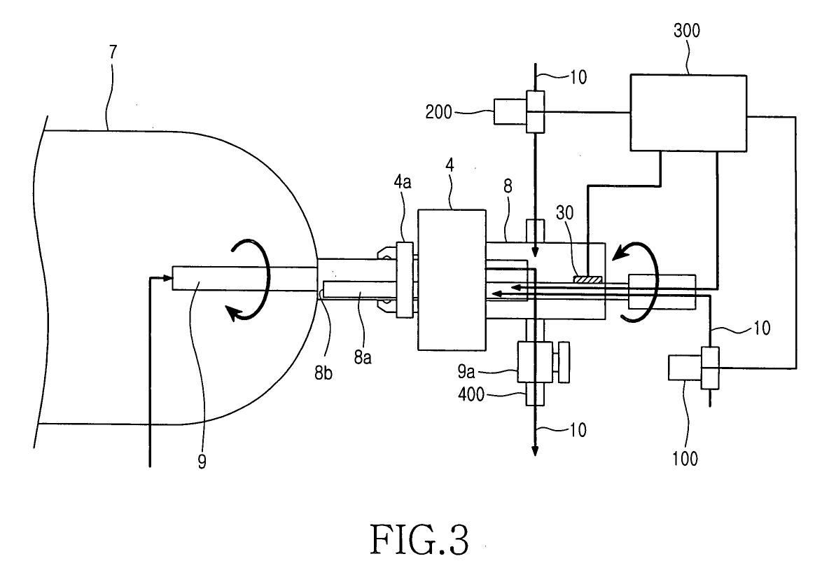

Referring to FIG. 3, the automatic pressure control device according to the present invention includes a main flow controller 100, a sub flow controller 200, and a gas pressure controller 300. A soot box 8 is coupled to one end of a quartz tube 7 in order to feed and discharge nitrogen gas 10 into and from the quartz tube 7. The soot box 8 has a chuck 4a that holds one end of the quartz tube 7. The main flow controller 100 is connected to the soot box 8 to control the flow rate of the gas 10 fed into the quartz tube 7 in accordance with a preset pressure value. The sub flow controller 200 is also coupled to the soot box 8 to control the flow rate of the gas 10 fed into the quartz tube 7 and maintain the preset pressure value when there is a pressure change within the soot box 8. A pressure sensor 30 is inserted into the soot box 8 to detect the pressure inside the quartz tube 7. The gas pressure controller 300 compares the pressure value of a signal detected in real time by the pressure sensor 30 with the preset pressure value. Upon detecting a difference between the two pressure values, the gas pressure controller 300 controls the sub flow controller 200 to feed the gas at a rate that will maintain a constant level of gas pressure within the soot box 8.

Under the control of the gas pressure controller 300, the main flow controller 100 controls the flow rate of the gas 10 so that the gas 10 can be fed into the soot box 8 in accordance with the preset pressure value. When there is a pressure change within the soot box 8, the sub flow controller 200 controls the flow rate of the gas 10 fed into the soot box 8 to maintain the preset pressure value under the control of the gas pressure controller 300.

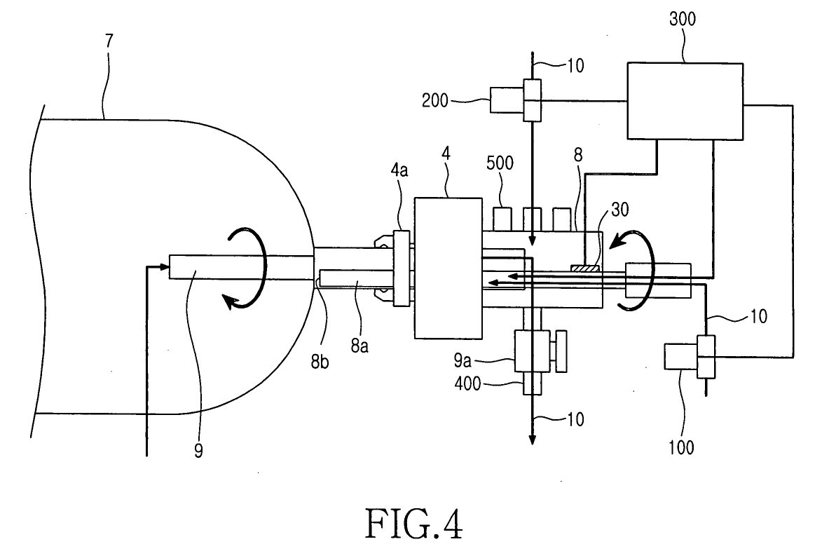

Referring to FIG. 4, a main gas outlet 400 for discharging undeposited soot and gas 10 by the operation of a hand valve 9a is provided at one side of the soot box 8. Also, sub gas outlets 500 for enhancing the discharge of the undeposited soot and gas 10 are provided at the opposition side of the soot box 8.

Hereinafter, the operation of the automatic pressure control device for a quartz tube according to the present invention will be explained in detail with reference to FIGS. 3 and 4.

A headstock 3 and a tailstock 4 that stand on a horizontal lathe to face each other are coupled to both ends of the quartz tube 7.

The tailstock 4 has a chuck 4a for holding one end of the quartz tube 7. The tailstock 4 is fixed to one end of the quartz tube 7 by means of the chuck 4a.

The soot box 8 is coupled to the tailstock 4 to feed and discharge the gas 10 into and from the quartz tube 7.

The main flow controller 100 for controlling the flow rate of the gas 10 fed into the quartz tube 7 is coupled to the soot box 8.

The pressure sensor 30 is inserted into the soot box 8 to detect gas pressure inside the quartz tube 7 in real time.

The pressure sensor 30 can detect any change in the pressure within the quartz tube 7 and applies a detected signal to the gas pressure controller 300.

The gas pressure controller 300 compares the pressure value of the detected signal with the preset pressure value. Upon detecting a difference between the pressure values, the gas pressure controller 300 controls the flow rate of the gas through the sub flow controller 200 so that the gas pressure within the soot box 8 can be maintained in a constant level.

The sub flow controller 200 constantly maintains the gas pressure within the soot box 8 by controlling the flow of the gas 10 fed into the soot box 8 to maintain the preset pressure value when there is a pressure change within the soot box 8.

As shown in FIG. 4, undeposited soot and gas 10 within the quartz tube 7 are discharged through the main gas outlet 400 and sub gas outlets 500 provided on the soot box 8.

Having thus described an embodiment of an apparatus for a method for detecting and automatically controlling the gas pressure within a quartz tube, it should be apparent to those skilled in the art that certain advantages when fabricating an optical preform have been achieved. In particular, it is possible to stabilize the gas pressure within the quartz tube even when there is an external cause of pressure change and a rapid discharge of undeposited soot and gas, thus improving the quality of an optical fiber preform.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. An automatic pressure control device for controlling a gas pressure within a quartz tube, comprising:
an optical fiber preform fabricating device having a chuck holding one end of the quartz tube and a soot box for feeding and discharging a gas into and from the quartz tube;
a main flow controller coupled to the soot box to feed the gas into the quartz tube in accordance with a preset pressure value;
a sub flow controller coupled to the soot box to feed the gas into the quartz tube to maintain the preset pressure value when there is a pressure change within the soot box; and
a gas pressure controller having a pressure sensor disposed inside the soot box to compare a pressure value of a signal detected in real time by the pressure sensor and the preset pressure value and to control the flow rate of the gas to maintain a constant level of gas pressure within the soot box.

2. The automatic pressure control device as claimed in claim 1, wherein the main flow controller feeds the gas into the soot box in accordance with the preset pressure value under the control of the gas pressure controller.

3. The automatic pressure control device as claimed in claim 1, wherein the sub flow controller feeds the gas into the soot box to maintain the preset pressure value under the control of the gas pressure controller when there is a pressure change in the soot box.

4. The automatic pressure control device as claimed in claim 1, further comprising a main gas outlet provided at one side of the soot box to discharge undeposited soot and gas by the operation of a hand valve and a plurality of sub gas outlets provided at the opposite side of the soot box to discharge the undeposited soot and gas.

5. An automatic pressure control device for controlling a gas pressure within a quartz tube, comprising:
an optical fiber preform fabricating device having a chuck holding one end of the quartz tube and a soot box for feeding and discharging gas into and from the quartz tube;
at least one flow controller for feeding the gas into the quartz tube in accordance with a preset pressure value and for controlling the flow rate of the gas fed into the quartz tube to maintain the preset pressure value when there is a pressure change within the soot box; and
a gas pressure controller having a pressure sensor disposed inside the soot box to compare a pressure value of a signal detected by the pressure sensor with the preset pressure value and to control the flow rate of the gas to maintain a constant level of gas pressure within the soot box.
